(19) United States
(12) Patent Application Publication
(10) Pub. No.: US 2012/0034703 A1
(43) Pub. Date: Feb. 9, 2012

(54) Devices, Systems and Methods for Processing of Magnetic Particles

(75) Inventors: Cung-Tuong Nguyen, Milpitas, CA (US); Kimberly L. Crawford, Emerald Hills, CA (US); Binh M. Lu, San Jose, CA (US)

(73) Assignee: AFFYMETRIX, INC., Santa Clara, CA (US)

(21) Appl. No.: 13/197,688

(22) Filed: Aug. 3, 2011

Related U.S. Application Data
(60) Provisional application No. 61/371,436, filed on Aug. 6, 2010.

(51) Int. Cl. G01N 1/00; B01L 3/00

(52) U.S. Cl. 436/174; 422/552

(57) ABSTRACT

Devices, systems and methods for separation of magnetic particles with either hand held devices or automated instruments. Specifically, the production of magnetic fields for the separation of the particles within containers such as microtiter plates with a magnetic field that is substantially consistent for each well. Certain embodiments produce a magnetic field that is substantially uniform across each well bottom, while other embodiments produce a magnetic field that is stronger toward the outer region of each well.

### RELATED APPLICATIONS

This application claims priority to U.S. Provisional Patent Application No. 61/371,436, filed Aug. 6, 2010, which is incorporated in its entirety herein for all purposes.

### FIELD OF INVENTION

Presently, disclosed are methods, devices and systems for performing fluidic processing of magnetic particles, including washing of magnetic particles. More particularly, disclosed are magnetic devices for fluidic processing of magnetic particles with either hand held or automated devices. In some embodiments, nucleic acids or proteins may be attached to the magnetic particles. For example, magnetic microspheres may have attached oligonucleotides for use in various assays. Disclosed are devices, methods and systems for washing magnetic particles using a hand held magnetic washing plate. Also disclosed are magnetic devices for washing magnetic particles with automated instruments. Whether the devices for fluidic processing are designed to be used by hand or within an automated instrument, embodiments are directed to more effective and efficient means for drawing magnetic particles to a portion of a container in a consistently uniform manner. Such magnetic particles may be used in molecular biology, genetics, biochemistry and other fields where purification of analytes may be performed using magnetic particles, such as magnetic microparticles, and in many embodiments, magnetic microspheres.

### BACKGROUND OF THE INVENTION

Global gene expression profiling and other technologies have identified a large number of genes whose expression is altered, such as in diseased tissues or in tissues and cells treated with pharmaceutical agents. (See, e.g., Lockhart and Winzeler, “Genomics, gene expression and DNA arrays,” Nature, 405(6788): 827-836 (2000); and Gunther et al., “Prediction of clinical drug efficacy by classification of drug-induced genomic expression profiles in vitro,” Proc. Natl. Acad. Sci. USA, 100(16): 9608-9613 (2003)). Such genes are being increasingly used as biomarkers in disease diagnosis, staging, and prognosis (See Golub et al., “Molecular Classification of Cancer: Class Discovery and Class Prediction by Gene Expression Monitoring,” Science, 286: 531-537 (1999)); target identification, validation and pathway analysis (See Roberts et al., “Signaling and circuitry of multiple MAPK pathways revealed by a matrix of global gene expression profiles,” Science, 287: 873-880 (2000)); drug screening (See Hamadeh et al., “Prediction of Compound Signature Using High Density Gene Expression Profiling,” Toxicol. Sci., 67(2): 232-240 (2002)); and studies of drug efficacy, structure-activity relationship, toxicity, and drug-target interactions (Gerhold et al., “Monitoring expression of genes involved in drug metabolism and toxicology using DNA microarrays,” Physiol. Genomics, 5: 161-170 (2001); and Thomas et al., “Identification of toxicologically predictive gene sets using cDNA microarrays,” Mol. Pharmacol., 60(6): 1189-1194 (2001)). As biomarkers are identified, their involvement in disease management and drug development will need to be evaluated in higher throughput and broader populations of samples. Simpler and more flexible expression profiling technology that allows the expression analysis of multiple genes with higher data quality and higher throughput is therefore needed.

Methods have been developed for microsphere based assays, either single or multiplex, including, for example, microsphere conjugation assays, nucleic acid amplification tests, including PCR and nucleic acid amplification based sequencing. Magnetic particles, such as magnetic microspheres, may be used for the purification of cells, proteins and nucleic acids. The size of the particles varies depending upon the assay in question and the desired assay characteristics. Accordingly, a wide variety of particle sizes are utilized with various assays, ranging from, for example, 1 micron in diameter to 300 or more microns in diameter. Fluidic processing of these magnetic particles and their attached molecules of interest is performed utilizing magnets in various forms and formats.

Common formats for the processing of magnetic particles include well plates of, for example, 24, 48, 96 or 384 wells. Various prior approaches have been utilized for the separation and washing of magnetic particles. U.S. Pat. No. 4,988,618 to Li et al., for example, disclose devices designed for sets of 96 wells or microtubes such that each tube or well is surrounded by four magnets, such as neodymium iron boron magnets. This results in the separation of magnetic particles into four areas within each microtube or well. This approach, however, makes it unlikely that the distribution of the magnetic particles into the four areas within each microtube or well will be uniform, and even more unlikely that the magnetic particles will be consistently distributed from microtube to microtube in a predictable manner, even within a single device within a particular assay as the exact manner of how the magnetic particles are deposited into the microtubes or wells, the characteristics of the suspending solution, and any vibration or shaking of the device is likely to result in irregular clumps of magnetic particles in all, or perhaps only some, of the four areas of each microtube or well. The more concentrated the distribution the particles are in a well, the more likely it becomes that fluidic steps such as washing lose efficacy and efficiency.

U.S. Pat. No. 5,779,907 to Yu discloses a magnetic microplate assembly which places a single magnet in the center of two by two arrangements of wells. While this allows a single magnet to attract magnetic particles within four wells, this approach necessarily creates a different distribution of magnetic particles within each well as the magnetic particles will be drawn to a different respective portion of the wall of the well within each particular group of four wells.

U.S. Pat. No. 7,629,151 to Gold et al. discloses various different approaches to the magnetic separation of paramagnetic beads. A first approach of Gold et al. follows the familiar approach of placing magnets adjacent to the wells in order to hold the beads to the sides of the wells. A second approach of Gold et al. utilizes magnetic bars such as a single bar can affect multiple wells. Gold et al. provide the example of using 8 magnetic bars for 8 rows of 12 wells. While this approach may minimize the number of total magnets utilized within a magnetic separation process, achieving a consistent, uniform distribution of the magnetic particles is more problematic because of the dependency on a single magnet affecting a plurality of wells.

A need remains for methods, systems and devices for the separation of magnetic particles in a manner that is uniform for each assay, and more particularly for each sample or well of the assay. Additionally, techniques to provide such uniform separation of magnetic particles over the entirety, or within pre-selected known portions of a well or other fluidic container, in an expedited manner without the use of larger, more powerful magnets than would otherwise be required are also needed.

### SUMMARY OF THE INVENTION

Embodiments of the present invention disclose magnetic particle processing devices designed to secure a container to a support frame with an associated plurality of magnetic particles for the subsequent separation of the magnetic particles within one or more fluids held in the container. In some embodiments the container may be a microtiter well plate with any suitable number of wells, such as 6, 12, 24, 48, 96, 384 or 1536 wells. Other container types, such as chambers, cuvettes or tubes are also possible depending on the type(s) of securing features utilized. One or more securing features may be utilized to secure the one or more containers to the support frame, with the type and number of securing features depending upon the precise layout and configuration of the support frame and container at issue within a particular assay. Possible securing features include tabs, latches, clips, clamps, hooks, press fit features, slides and screws.

Embodiments may place the plurality of magnets on top of the support frame, or within the support frame. The number and configuration of the magnets will depend upon factors such as the magnetic particles to be utilized within the assay, the number and type of assay steps, and the container(s) to be utilized within the assay. Generally the magnetic field applied to each portion of the container at issue that will hold magnetic particles (e.g., each well of a microtiter plate) will be subject to a magnetic field that is substantially consistent when comparing one well of the microtiter plate to another well. Producing a consistent magnetic field aids, for example, assay consistency and predictability. In some embodiments, this may lead to having a set of one or more magnets with respect to each well, cuvette, tube, etc. For example, a support frame designed to interface with a 96-well microtiter plate may have 96 magnets, or in other embodiments, 96 sets of magnets (e.g., 96 sets of 4, 5, 6, 7, 8 or 9 magnets). Magnets of any suitable type, with respect to the characteristics of the magnetic particles at issue and desired assay characteristics, may be utilized with the disclosed embodiments. Such magnets may include magnets utilizing paramagnetic, ferromagnetic, or ferrimagnetic materials, or combinations of these materials, such as rare earth, neodymium, neodymium iron boron, or samarium cobalt magnets.

In some embodiments, whether for hand held manual processing of magnetic particles or for automated processing within one or more automated instruments, the support frame will additionally include one or more identification features. The type and number of identification features will depend on the particular embodiment and factors such as whether the identification features are meant to be recognized by a human user or an automated instrument and the size and configuration of the support frame and the container(s) at issue. Identification features may be characters, numbers, color markings, physical features, or a combination of these. Embodiments, particularly embodiments directed to hand held processing devices, may additionally include one or more gripping features to aid a user in manipulating the processing device during the assay. Possible gripping features include rubber gaskets and/or modifying the exterior regions of the support frame to aid user manipulation of the processing device.

Certain embodiments are designed such that the magnets of the support frame are configured to produce a magnetic field that is substantially uniform across the bottom of portions of the container holding the magnetic particles (e.g., the bottom of the wells of a microtiter plate). A uniform magnetic field across the bottom of each well will favor a more even distribution of magnetic particles across the well bottom, as opposed to encouraging the concentration of magnetic particles in select areas. A more even distribution aids fluidic processing effectiveness and efficiency as it will generally lead to a faster, more through and consistent exposure of the magnetic particles (any directly or indirectly attached probes, analytes, targets, samples, etc.) to the fluid(s) at issue within the assay, such as fluids containing samples or targets, washing fluids, staining fluids, etc. In some embodiments, the substantially uniform and consistent magnetic field for each well is produced by configuring the magnets of the support frame such that each well of a microtiter plate will be secured directly above one magnet, where the magnet is roughly the same diameter as the well.

In other embodiments, the magnets are configured to produce a magnetic field that is stronger toward the outer regions of each well, toward the walls of the wells, and that is weaker toward the center of each well. Such magnetic fields will generally encourage the attraction of magnetic particles at the bottom of wells toward the walls, with fewer magnetic particles toward the center region of the well bottoms. These embodiments can be advantageous when the assay involves removal of at least a portion of the fluid within which are the magnetic particles (e.g., removing at least some of the fluid from a well containing magnetic particles). This removal of fluid can be by any suitable method known in the art, such as by pipetting or vacuum suction. Generally, placing the instrument to remove the fluid, such as a pipette tip or tube with which to aspirate the fluid, within the center of a well is easier than placing the instrument toward the wall of the well as such placement allows for greater tolerances while avoiding placement errors (such as accidently striking the microtiter plate instead of placing the pipette tip within a well). By creating a magnetic field that favors distribution of magnetic particles on the bottom of the well, but toward the walls of the well, fluid may be removed from the center of the well bottom while minimizing removal of the magnetic particles.

The disclosed embodiments include both manual hand held processing devices and automated robotic instruments. The principles of the magnet configuration and the resulting various types of magnetic fields are largely the same regardless of whether the processing is done manually or in an automated fashion, but automated instruments offer the advantages of higher throughput and hands off processing of multiple assay steps. Many fluidic processing instruments for magnetic particles, such as washing instruments, are known in the art, and may be modified by use of a support frame and magnet configuration according to one of the disclosed embodiments to facilitate the production of a magnetic field that is consistent for each well or other particle holding portion of a container, and that is either substantially uniform across, e.g., the well, or that is stronger in the outer region of the well while weaker toward the center. Use of automated instruments set to follow particular protocols for the assay in question allow the hands off processing of multiple fluidic steps, such as multiple washing and/or staining steps, of the magnetic particles at issue, with the instrument performing cycles of adding a desired fluid or fluids to the wells and subsequently removing them at a desired time.

### BRIEF DESCRIPTION OF THE DRAWINGS

The accompanying drawings, which are incorporated in and form a part of this specification, illustrate embodiments and, together with the description, serve to explain various aspects:

FIGS. 1A and 1B depict an example of a hand held magnetic processing device. FIG. 1A shows an overview of the schematic from an angled view from above, and FIG. 1B overview, FIG. 1B illustrates the locking mechanism, FIG. 1C shows a top view and FIG. 1D shows a cross-section view of the device.

FIGS. 2 and 3 illustrate other embodiments of a hand held magnetic device.

FIGS. 4A-4F illustrate various examples of possible magnet configurations for use within hand held magnetic devices or within automated instruments for fluidic processing of magnetic particles.

FIG. 5 illustrates a single container, such as the well of a microtiter plate, with respect to a magnet configuration of a particular disclosed embodiment.

### DETAILED DESCRIPTION OF THE INVENTION

Although the invention is described in conjunction with the exemplary embodiments, the invention is not limited to these embodiments. On the contrary, the invention encompasses alternatives, modifications and equivalents, which may be included within the spirit and scope of the invention. The invention has many embodiments and relies on many patents, applications and other references for details known to those of the art. Therefore, when a patent, application, website or other reference is cited or repeated below, the entire disclosure of the document cited is incorporated by reference in its entirety for all purposes as well as for the proposition that is recited. All documents, e.g., publications and patent applications, cited in this disclosure, including the foregoing, are incorporated herein by reference in their entireties for all purposes to the same extent as if each of the individual documents were specifically and individually indicated to be so incorporated herein by reference in its entirety.

Unless defined otherwise, all technical and scientific terms used herein have the same meaning as commonly understood by one of ordinary skill in the art to which the invention pertains. The following definitions supplement those in the art and are directed to the current application and are not to be imputed to any related or unrelated case, e.g., to any commonly owned patent or application. Although any methods and materials similar or equivalent to those described herein can be used in the practice for testing of the present invention, the preferred materials and methods are described herein. Accordingly, the terminology used herein is for the purpose of describing particular embodiments only, and is not intended to be limiting.

As used in this application, the singular form “a,” “an,” and “the” include plural references unless the context clearly dictates otherwise. The term “an agent,” for example, includes a plurality of agents, including mixtures thereof.

Throughout this disclosure, various aspects of this invention can be presented in a range format. When a description is provided in range format, this is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

The invention may employ arrays of probes on solid substrates in some embodiments. Methods and techniques applicable to polymer (including nucleic acid and protein) array synthesis have been described in, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, and in WO 99/36760 and WO 01/58593, which are all incorporated herein by reference in their entirety for all purposes. Patents that describe synthesis techniques include U.S. Pat. Nos. 5,412,087, 6,147,205, 6,262,216, 6,310,189, 5,889,165, and 5,959,098. Nucleic acid probe arrays are described in many of the above patents, but the same techniques are applied to polypeptide probe arrays.

Probe arrays have many uses including, but are not limited to, gene expression monitoring, profiling, library screening, genotyping and diagnostics. Methods of gene expression monitoring and profiling are described in U.S. Pat. Nos. 5,800,992, 6,013,449, 6,020,135, 6,033,860, 6,040,138, 6,177,248 and 6,309,822. Genotyping methods, and uses thereof, are disclosed in U.S. patent application Ser. No. 10/442,021 (abandoned) and U.S. Pat. Nos. 5,856,092, 6,300,063, 5,858,659, 6,284,460, 6,361,947, 6,368,799, 6,333,179, and 6,872,529. Other uses are described in U.S. Pat. Nos. 5,871,928, 5,902,723, 6,045,996, 5,541,061, and 6,197,506.

Samples, RNA, DNA sample, cell culture, tissue, Formalin-Fixed Paraffin-Embedded tissue (FFPE), blood, plants, and protein prep sample, etc., can be processed by various methods before analysis. Prior to, or concurrent with, analysis a nucleic acid sample may be amplified by a variety of mechanisms, some of which may employ PCR. (See, for example, PCR Technology: Principles and Applications for DNA Amplification, Ed. H. A. Erlich, Freeman Press, NY, N.Y., 1992; PCR Protocols: A Guide to Methods and Applications, Eds. Innis, et al., Academic Press, San Diego, Calif., 1990; Mattila et al., Nucleic Acids Res., 19:4967, 1991; Eckert et al., PCR Methods and Applications, 1:17, 1991; PCR, Eds. McPherson et al., IRL Press, Oxford, 1991; and U.S. Pat. Nos. 4,683,202, 4,683,195, 4,800,159 4,965,188, and 5,333,675, each of which is incorporated herein by reference in their entireties for all purposes. The sample may also be amplified on the probe array. (See, for example, U.S. Pat. No. 6,300,070 and U.S. patent application Ser. No. 09/513,300 (abandoned), all of which are incorporated herein by reference).

Other suitable amplification methods include the ligase chain reaction (LCR) (see, for example, Wu and Wallace, Genomics, 4:560 (1989), Landegren et al., Science, 241:1077 (1988) and Barringer et al., Gene, 89:117 (1990)), transcription amplification (Kwoh et al., Proc. Natl. Acad. Sci. USA, 86:1173 (1989) and WO 88/10315), self-sustained sequence replication (Guatelli et al., Proc. Nat. Acad. Sci. USA, 87:1874 (1990) and WO 90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5, 413,909 and 5,861,245) and nucleic acid based sequence amplification (NABSA). (See also, U.S. Pat. Nos. 5,409,818, 5,554,517, and 6,063,603, each of which is incorporated herein by reference). Other amplification methods that may be used are described in, for instance, U.S. Pat. Nos. 6,582,938, 5,242,794, 5,494,810, and 4,988,617, each of which is incorporated herein by reference.

Additional methods of sample preparation and techniques for reducing the complexity of a nucleic sample are described in Dong et al., Genome Research, 11:1418 (2001), U.S. Pat. Nos. 6,361,947, 6,391,592, 6,632,611, 6,872,529 and 6,958,225, and in U.S. patent application Ser. No. 09/916,135 (abandoned).

Hybridization assay procedures and conditions vary depending on the application and are selected in accordance with known general binding methods, including those referred to in Maniatis et al., Molecular Cloning: A Laboratory Manual, 2^{nd} Ed., Cold Spring Harbor, N.Y., (1989); Berger and Kimmel, Methods in Enzymology, Guide to Molecular Cloning Techniques, Vol. 152, Academic Press, Inc., San Diego, Calif. (1987); Young and Davism, Proc. Nat'l. Acad. Sci., 80:1194 (1983). Methods and apparatus for performing repeated and controlled hybridization reactions have been described in, for example, U.S. Pat. Nos. 5,871,928, 5,874,219, 6,045,996, 6,386,749, and 6,391,623 each of which are incorporated herein by reference.

### I. Definitions

The term “about” as used herein indicates the value of a given quantity varies by +/−10% of the value, or optionally +/−5% of the value, or in some embodiments, by +/−1% of the value so described.

The term “array” as used herein refers to an intentionally created collection of molecules which can be prepared either synthetically or biosynthetically. The molecules in the array can be identical or different from each other. The array can assume a variety of formats, including, but not limited to, libraries of soluble molecules, and libraries of compounds tethered to particles, resin microspheres, microspheres, magnetic microspheres, encoded microparticles, silica chips, or other solid supports. An array may include polymers of a given length having all possible monomer sequences made up of a specific set of monomers, or a specific subset of such an array. In other cases an array may be formed from inorganic materials. (See, Schultz et al., PCT application WO 96/11878).

The term “hybridization” as used herein refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” The proportion of the population of polynucleotides that forms stable hybrids is referred to herein as the “degree of hybridization.” Hybridizations are usually performed under stringent conditions, for example, at a salt concentration of no more than about 1 M and a temperature of at least 25° C. For example, conditions of 5× SSPE (750 mM NaCl, 50 mM NaPhosphate, 5 mM EDTA, pH 7.4) and a temperature of 25-30° C. are suitable for allele-specific probe hybridizations or conditions of 100 mM MES, 1 M [Na+], 20 mM EDTA, 0.01% Tween-20 and a temperature of 30-50° C., or at about 45-50° C. Hybridizations may be performed in the presence of agents such as herring sperm DNA at about 0.1 mg/ml, acetylated BSA at about 0.5 mg/ml. As other factors may affect the stringency of hybridization, including base composition and length of the complementary strands, presence of organic solvents and extent of base mismatching, the combination of parameters is more important than the absolute measure of any one alone. Hybridization conditions suitable for microarrays are described in the Gene Expression Technical Manual, 2004 and the GENECHIP® Mapping Assay Manual, 2004. Hybridization signals can be detected by conventional methods, such as described by, e.g., U.S. Pat. Nos. 5,143,854, 5,578,832, 5,631,734, 5,834,758, 5,936,324, 5,981,956, 6,025,601, 6,141,096, 6,185,030, 6,201,639, 6,218,803, and 6,225,625, U.S. patent application Ser. No. 10/389,194 (U.S. Patent Application Publication No. 2004/0012676, allowed on Nov. 9, 2009) and PCT Application PCT/US99/06097 (published as WO 99/47964), each of which is hereby incorporated by reference in its entirety for all purposes).

The term “monomer” as used herein refers to any member of the set of molecules that can be joined together to form an oligomer or polymer. The set of monomers useful in the invention includes nucleotides and nucleosides for nucleic acid synthesis and the set of L-amino acids, D-amino acids, or synthetic amino acids for polypeptide synthesis. Different basis sets of monomers may be used at successive steps in the synthesis of a polymer.

The term “nucleic acid” as used herein refers to a polymeric form of nucleotides of any length, either ribonucleotides, deoxyribonucleotides or peptide nucleic acids (PNAs) or (Locked nucleic acids, LNAs), that include purine and pyrimidine bases, or other natural, chemically or biochemically modified, non-natural, or derivatized nucleotide bases. Nucleic acids can be single or double stranded. The backbone of the nucleic acid can include sugars and phosphate groups, as may typically be found in RNA or DNA, or modified or substituted sugar or phosphate groups. A nucleic acid may include modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

Nucleic acids can be isolated from natural sources, recombinantly produced or artificially synthesized and mimetics thereof, such as LNA, “Locked nucleic acid”. A further example of a nucleic acid is a peptide nucleic acid (PNA). Double stranded nucleic acid usually pair by Watson-Crick pairing but can also pair by Hoogsteen base pairing which has been identified in certain tRNA molecules and postulated to exist in a triple helix. The term “oligonucleotide” refers to a nucleic acid of about 7-100 bases, (e.g., 10-50 or 15-25).

A probe has specific affinity for a target or analyte in a sample. For nucleic acid probes and nucleic acid targets, specific affinity is primarily determined by ability to form Watson Crick complementary base pairs on hybridization. For example, an oligonucleotide probe can be designed to be perfectly complementary to its intended target. Targets may be naturally-occurring or man-made molecules. Also, they can be employed in their unaltered state or as aggregates with other species. Targets may be attached, covalently or noncovalently, to a binding member, either directly or via a specific binding substance. Examples of targets include antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. U.S. Pat. No. 6,582,908 provides an example of probe arrays having all possible combinations of nucleic acid-based probes having a length of 10 bases, and 12 bases or more. Nucleic acid probes can be, for example, olignucleotides or cDNAs. Probes can be linear. A probe may also consist of an open circle molecule, comprising a nucleic acid having left and right arms whose sequences are complementary to the target, and separated by a linker region (see, e.g., U.S. Pat. No. 6,858,412, and Hardenbol et al., Nat. Biotechnol., 21(6):673 (2003)). A probe, such as a nucleic acid can be attached directly to a support (optionally drivatized with a linker). A probe can also be attached to a microparticle, and the microparticle attached to the support, for example, in an indentation or divot in the support. Examples of encoded microparticles, methods of making the same, methods for fabricating the microparticles, methods and systems for detecting microparticles, and the methods and systems for using microparticles are described in U.S. Patent Application Publication Nos. 20080038559, 20070148599, and PCT Application No. WO 2007/081410 (all incorporated by reference). Such microparticles are preferably encoded such that the identity of a probe borne by a microparticles can be read from a distinguishable code. The code can be in the form of a tag, which may itself be a probe, such as an oligonucleotide, a detectable label, such as a fluorophore, or embedded in the microparticle, for example, as a bar code. Microparticles bearing different probes have different codes. Microparticles are typically distributed on a support by a sorting process in which a collection of microparticles are placed on the support and the microparticles distribute to areas of the support. The areas can be defined by indentations, by sticky patches among other methods. A “Probe Target Pair” is formed when two macromolecules have combined through molecular recognition to form a complex.

The term “substrate” refers to a material or group of materials having a rigid, semi-rigid surface or flexible surface suitable for attaching an array of probes. In one embodiment, the surface may be a combination of materials where at least one layer is flexible. Surfaces on the solid substrate can be of the same material as the substrate. In another embodiment, the substrate may be fabricated form a single material or be fabricated of two or more materials. Thus, the surface may be composed of any of a wide variety of materials, for example, polymers, plastics, resins, polysaccharides, silica or silica-based materials, carbon, metals, inorganic glasses, membranes, or any of the above-listed substrate materials. In a further embodiment, the surface can be supported by a flexible material or a solid material. In many embodiments, at least one surface of the substrate is flat, although in some embodiments it may be desirable to physically separate synthesis regions for different compounds with, for example, wells, raised regions, pins, etched trenches, or the like. According to other embodiments, the substrate takes the form of particles, microspheres, resins, gels, microspheres, or other geometric configurations. (See, U.S. Pat. No. 5,744,305 for exemplary substrate, which is hereby incorporated by reference herein in its entirety for all purpose).

The term “target” as used herein refers to a molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. Targets are sometimes referred to in the art as anti-probes. As the term target is used herein, no difference in meaning is intended. A “Probe Target Pair” is formed when two macromolecules have combined through molecular recognition to form a complex.

The term “polynucleotide” (and the equivalent term “nucleic acid”) encompasses any physical string of monomer units that can be corresponded to a string of nucleotides, including a polymer of nucleotides (e.g., a typical DNA or RNA polymer), peptide nucleic acids (PNAs), modified oligonucleotides (e.g., oligonucleotides comprising nucleotides that are not typical to biological RNA or DNA, such as 2′-O-methylated oligonucleotides), and the like. The nucleotides of the polynucleotide can be deoxyribonucleotides, ribonucleotides or nucleotide analogs, can be natural or non-natural, and can be unsubstituted, unmodified, substituted or modified. The nucleotides can be linked by phosphodiester bonds, or by phosphorothioate linkages, methylphosphonate linkages, boranophosphate linkages, or the like. The polynucleotide can additionally comprise non-nucleotide elements such as labels, quenchers, blocking groups, or the like. The polynucleotide can be, e.g., single-stranded or double-stranded.

A “polynucleotide sequence” or “nucleotide sequence” is a polymer of nucleotides (an oligonucleotide, a DNA, a nucleic acid, etc.) or a character string representing a nucleotide polymer, depending on context. From any specified polynucleotide sequence, either the given nucleic acid or the complementary polynucleotide sequence (e.g., the complementary nucleic acid) can be determined.

Two polynucleotides “hybridize” when they associate to form a stable duplex, e.g., under relevant assay conditions. Nucleic acids hybridize due to a variety of well characterized physico-chemical forces, such as hydrogen bonding, solvent exclusion, base stacking and the like. An extensive guide to the hybridization of nucleic acids is found in Tijssen (1993) Laboratory Techniques in Biochemistry and Molecular Biology-Hybridization with Nucleic Acid Probes, part I chapter 2, “Overview of principles of hybridization and the strategy of nucleic acid probe assays” (Elsevier, N.Y.), as well as in Ausubel, infra.

The “Tₘ” (melting temperature) of a nucleic acid duplex under specified conditions (e.g., relevant assay conditions) is the temperature at which half of the base pairs in a population of the duplex are disassociated and half are associated. The Tₘ for a particular duplex can be calculated and/or measured, e.g., by obtaining a thermal denaturation curve for the duplex (where the Tₘ is the temperature corresponding to the midpoint in the observed transition from double-stranded to single-stranded form).

The term “complementary” refers to a polynucleotide that forms a stable duplex with its “complement,” e.g., under relevant assay conditions. Typically, two polynucleotide sequences that are complementary to each other have mismatches at less than about 20% of the bases, at less than about 10% of the bases, preferably at less than about 5% of the bases, and more preferably have no mismatches.

A “capture extender” or “CE” is a polynucleotide that is capable of hybridizing to a nucleic acid of interest and to a capture probe. The capture extender typically has a first polynucleotide sequence C-1, which is complementary to the capture probe, and a second polynucleotide sequence C-3, which is complementary to a polynucleotide sequence of the nucleic acid of interest. Sequences C-1 and C-3 are typically not complementary to each other. The capture extender is preferably single-stranded.

A “capture probe” or “CP” is a polynucleotide that is capable of hybridizing to at least one capture extender and that is tightly bound (e.g., covalently or noncovalently, directly or through a linker, e.g., streptavidin-biotin or the like) to a solid support, a spatially addressable solid support, a slide, a particle, a microsphere, or the like. The capture probe typically comprises at least one polynucleotide sequence C-2 that is complementary to polynucleotide sequence C-1 of at least one capture extender. The capture probe is preferably single-stranded.

A “label extender” or “LE” is a polynucleotide that is capable of hybridizing to a nucleic acid of interest and to a label probe system. The label extender typically has a first polynucleotide sequence L-1, which is complementary to a polynucleotide sequence of the nucleic acid of interest, and a second polynucleotide sequence L-2, which is complementary to a polynucleotide sequence of the label probe system (e.g., L-2 can be complementary to a polynucleotide sequence of an amplification multimer, a preamplifier, a label probe, or the like). The label extender is preferably single-stranded.

A “label” is a moiety that facilitates detection of a molecule. Common labels in the context of the present invention include fluorescent, luminescent, light-scattering, and/or colorimetric labels. Suitable labels include enzymes and fluorescent moieties, as well as radionuclides, substrates, cofactors, inhibitors, chemiluminescent moieties, magnetic particles, and the like. Patents teaching the use of such labels include U.S. Pat. Nos. 3,817,837; 3,850,752; 3,939,350; 3,996,345; 4,277,437; 4,275,149; and 4,366,241. Many labels are commercially available and can be used in the context of the invention.

A “label probe system” comprises one or more polynucleotides that collectively comprise a label and a polynucleotide sequence M-1, which is capable of hybridizing to at least one label extender. The label provides a signal, directly or indirectly. Polynucleotide sequence M-1 is typically complementary to sequence L-2 in the label extenders. The label probe system can include a plurality of label probes (e.g., a plurality of identical label probes) and an amplification multimer; it optionally also includes a preamplifier or the like, or optionally includes only label probes, for example.

An “amplification multimer” is a polynucleotide comprising a plurality of polynucleotide sequences M-2, typically (but not necessarily) identical polynucleotide sequences M-2. Polynucleotide sequence M-2 is complementary to a polynucleotide sequence in the label probe. The amplification multimer also includes at least one polynucleotide sequence that is capable of hybridizing to a label extender or to a nucleic acid that hybridizes to the label extender, e.g., a preamplifier. For example, the amplification multimer optionally includes at least one polynucleotide sequence M-1; polynucleotide sequence M-1 is typically complementary to polynucleotide sequence L-2 of the label extenders. Similarly, the amplification multimer optionally includes at least one polynucleotide sequence that is complementary to a polynucleotide sequence in a preamplifier. The amplification multimer can be, e.g., a linear or a branched nucleic acid. As noted for all polynucleotides, the amplification multimer can include modified nucleotides and/or nonstandard internucleotide linkages as well as standard deoxyribonucleotides, ribonucleotides, and/or phosphodiester bonds. Suitable amplification multimers are described, for example, in U.S. Pat. No. 5,635,352, U.S. Pat. No. 5,124,246, U.S. Pat. No. 5,710,264, and U.S. Pat. No. 5,849,481.

A “label probe” or “LP” is a single-stranded polynucleotide that comprises a label (or optionally that is configured to bind to a label) that directly or indirectly provides a detectable signal. The label probe typically comprises a polynucleotide sequence that is complementary to the repeating polynucleotide sequence M-2 of the amplification multimer; however, if no amplification multimer is used in the branched DNA (bDNA) assay, the label probe can, e.g., hybridize directly to a label extender.

A “preamplifier” is a nucleic acid that serves as an intermediate between at least one label extender and amplification multimer. Typically, the preamplifier is capable of hybridizing simultaneously to at least one label extender and to a plurality of amplification multimers.

A “microorganism” is an organism of microscopic or submicroscopic size. Examples include, but are not limited to, bacteria, fungi, yeast, protozoans, microscopic algae (e.g., unicellular algae), viruses (which are typically included in this category although they are incapable of growth and reproduction outside of host cells), subviral agents, viroids, and mycoplasma.

### II. Specific Embodiments

In various embodiments, methods, devices and systems for processing of magnetic particles such as microspheres, microspheres, encoded microparticles, etc., are provided. Magnetic particles are commonly used for purification of cells, proteins and nucleic acids. Magnets of various form and format may be constructed to function with different vessels of different sizes, shapes and compositions. Recently, magnetic microspheres have been used for protein and nucleic acid based assays, including the application of color coded magnetic particles for multiplex assays, for example, LUMINEX® (Austin, Tex.) assays and encoded microparticles.

According to various embodiments, magnetic particles can be any particles with magnetic properties. A variety of inert materials are known in the art which can be utilized to create magnetic particles. The magnetic particles can be made from any material that is compatible with the chemical reactants and solvents that are placed in the wells. Any of a variety of organic or inorganic materials, or combinations thereof, may be employed for the magnetic particles, including, for example, metals, stainless steel, ceramics, polypropylene, polystyrene, polyvinyl chloride, polycarbonate, polysulfone, nylon, polytetrafluoroethylene, silicon, fused silica, quartz or glass, iron oxide core, and the like. The magnetic particles may be manufactured in various shapes, for example, square, octagon, rectangle, cylinder, oval, circular, and so forth. In an alternate embodiment, the particles can be coated with a material that would make the particles compatible with the assay, such as a silane, a hydrophobic coating, or a magnetic coating, such as a paramagnetic, diamagnetic, ferromagnetic, or supermagnetic coating.

The diameter of the magnetic particles is dependent on several factors, such as, the dimensions of the container, volume of target hybridization solution to be mixed, etc. Accordingly, the diameter of the magnetic particles will vary depending on the particular embodiment, and may range, for example, from about 1 to about 400 microns, including particles with diameters of, for instance, 1.0, 1.25, 1.5, 2.0, 2.5, 3, 4, 5, 6, 7, 8, 9, 10, 12.5, 15, and 20 microns. Other embodiments may utilize particles outside this range, for example, diameters of 0.5, 0.75, or 450 microns, depending upon the particular design goals and requirements of the assay in questions.

In some embodiments, the particles are microspheres, since they are generally stable, are widely available in a range of materials, surface chemistries and uniform sizes, and can be fluorescently dyed. A “microsphere” as used herein is a generally spherical, or roughly spherical, particle with a diameter in the micrometer range (under 1000 microns). Microspheres can be distinguished from each other by multiple techniques known in the art, such as by size, shape, and/or detection of labels that are attached directly or indirectly (e.g., detection of a fluorescently labeled microsphere).

Luminex Corporation (Austin, Tex.), for example, offers uniform diameter polystyrene microspheres in up to 500 distinct sets to enable multiplexing of up to 500 analytes per well. The microspheres of each set are internally labeled with a distinct ratio of two fluorophores. A flow cytometer or other suitable instrument can thus be used to classify each individual microsphere according to its predefined fluorescent emission ratio. Fluorescently-coded microsphere sets are also available from a number of other suppliers, including Radix BioSolutions (Georgetown, Tex.) and Millipore Corporation (Billerica, Mass.). Alternatively, Becton, Dickinson and Company Biosciences (San Jose, Calif.) and Bangs Laboratories, Inc. (Fishers, Ind.) offer microsphere sets distinguishable by a combination of fluorescence and size. Some embodiments may distinguish microspheres or microparticles in general on the basis of size alone, or other physical or chemical properties, without the use of distinguishable fluorescent labels. For example, distinguishable digital bar codes built into the microparticles may be utilized to distinguish one type from another.

Microspheres with a variety of surface chemistries are commercially available, from the above suppliers and others (See, e.g., Kellar and Iannone, “Multiplexed microsphere-based flow cytometric assays,” Experimental Hematology 30: 1227-1237 (2002); and Fitzgerald, “Assays by the score,” The Scientist 15[11]: 25 (2001)). For example, microspheres with carboxyl, hydrazide or maleimide groups are available and permit covalent coupling of molecules (e.g., polynucleotide capture probes with free amine, carboxyl, aldehyde, sulfhydryl or other reactive groups) to the microspheres. As another example, microspheres with surface avidin or streptavidin are available and can bind biotinylated capture probes; similarly, microspheres coated with biotin are available for binding capture probes conjugated to avidin or streptavidin.

Protocols for using such commercially available microspheres (e.g., methods of covalently coupling polynucleotides to carboxylated microspheres for use as capture probes, methods of blocking reactive sites on the microsphere surface that are not occupied by the polynucleotides, methods of binding biotinylated polynucleotides to avidin-functionalized microspheres, and the like) are typically supplied with the microspheres and are readily utilized and/or adapted by one of skill. In addition, coupling of reagents to microspheres is well described in the literature and known in the art. Methods of analyzing microsphere populations (e.g., methods of identifying microsphere subsets by their size and/or fluorescence characteristics, methods of using size to distinguish microsphere aggregates from single uniformly sized microspheres and eliminate aggregates from the analysis, methods of detecting the presence or absence of a fluorescent label on the microsphere subset, and the like) are also well described in the literature. (See, e.g., Yang et al., “BADGE, Microspheres Array for the Detection of Gene Expression, a high-throughput diagnostic bioassay,” Genome Res., 11: 1888-1898 (2001); Fulton et al., “Advanced multiplexed analysis with the FlowMetrix system,” Clinical Chemistry 43: 1749-1756 (1997); Jones et al., “Multiplex assay for detection of strain-specific antibodies against the two variable regions of the G protein of respiratory syncytial virus,” Clinical and Diagnostic Laboratory Immunology, 9(3): 633-638 (2002); Camilla et al., “Flow cytometric microsphere-based immunoassay: Analysis of secreted cytokines in whole-blood samples from asthmatics,” Clinical and Diagnostic Laboratory Immunology 8:776-784 (2001); Martins, “Development of internal controls for the Luminex instrument as part of a multiplexed seven-analyte viral respiratory antibody profile,” Clinical and Diagnostic Laboratory Immunology 9:41-45 (2002); Kellar and Iannone, “Multiplexed microsphere-based flow cytometric assays,” Experimental Hematology 30: 1227-1237 (2002); Oliver et al., “Multiplexed analysis of human cytokines by use of the FlowMetrix system,” Clinical Chemistry 44: 2057-2060 (1998); Gordon and McDade, “Multiplexed quantification of human IgG, IgA, and IgM with the FlowMetrix system,” Clinical Chemistry 43:1799-1801 (1997); U.S. Pat. No. 5,981,180, entitled “Multiplexed analysis of clinical specimens apparatus and methods,” to Chandler et al. (Nov. 9, 1999); U.S. Pat. No. 6,449,562, entitled “Multiplexed analysis of clinical specimens apparatus and methods,” to Chandler et al. (Sep. 10, 2002); and references therein.

Suitable instruments, software, and the like for analyzing microsphere populations to distinguish subsets of microspheres and to detect the presence or absence of a label (e.g., a fluorescently labeled label probe) on each subset are commercially available. For example, flow cytometers are widely available, e.g., from Becton, Dickinson and Company Biosciences (San Jose, Calif.) and Beckman Coulter, Inc. (Brea, Calif.). Some approaches utilize microfluidics to align microspheres and two different lasers to excite two fluorescent labels associated with the microparticles and the target of interest within, for example, one well of a well plate at a time, with extraction of the microparticles from each well done in series or a limited parallel fashion. Other approaches may combine a confocal microplate reader with one or more lasers to detect and read fluorescent labels within the wells of the well plate itself.

The microspheres described above can be made magnetic. It is also understood by any person skilled in the art that there are no limitations as to the type of magnetic field that can be applied, for example, paramagnetic, ferromagnetic, diamagnetic, or super magnetic. There are commercially available magnetic microspheres, for example, MagPlex® Microspheres from Luminex (Austin, Tex.) orBioMag® Magnetic Microspheres from Bangs Laboratories, Inc. (Fishers, Ind.). Another example of particles that can be adapted for use include sets of microparticles that contain embedded digital holographic elements within each microparticle such that each microparticle emits a particular code image when excited by a laser, with such microparticles being available from Illumina, Inc. (San Diego, Calif.).

According to other embodiments, the magnetic particles can be encoded microparticles. For example, functionalized silicon compounds may be covalently attached to encoded microparticles. The probes are then attached to the microparticles. Examples of encoded microparticles, methods of making the same, methods for fabricating the microparticles, methods and systems for detecting microparticles, and the methods and systems for using microparticles are described in U.S. Patent Application Publication Nos. 2008/0038559, 2007/0148599, and PCT Publication No. WO 2007/081410, each of which is hereby incorporated by reference in its entirety for all purposes. According to some embodiments, the fabrication of digital, lithographically-encoded glass microparticles may involve deposition of a silicon oxide layer on a silicon wafer, deposition of a polysilicon layer, deposition of a hard-mask oxide layer, patterning the hard-mask layer for photolithographic encoding, etching of the polysilicon layer, deposition of a top silicon oxide layer to encase the photolithographic code in glass, etching a defined particle border, and removal of the particle from the silicon substrate.

### Devices, Methods and Systems Using a Hand Held Magnetic Processing Device

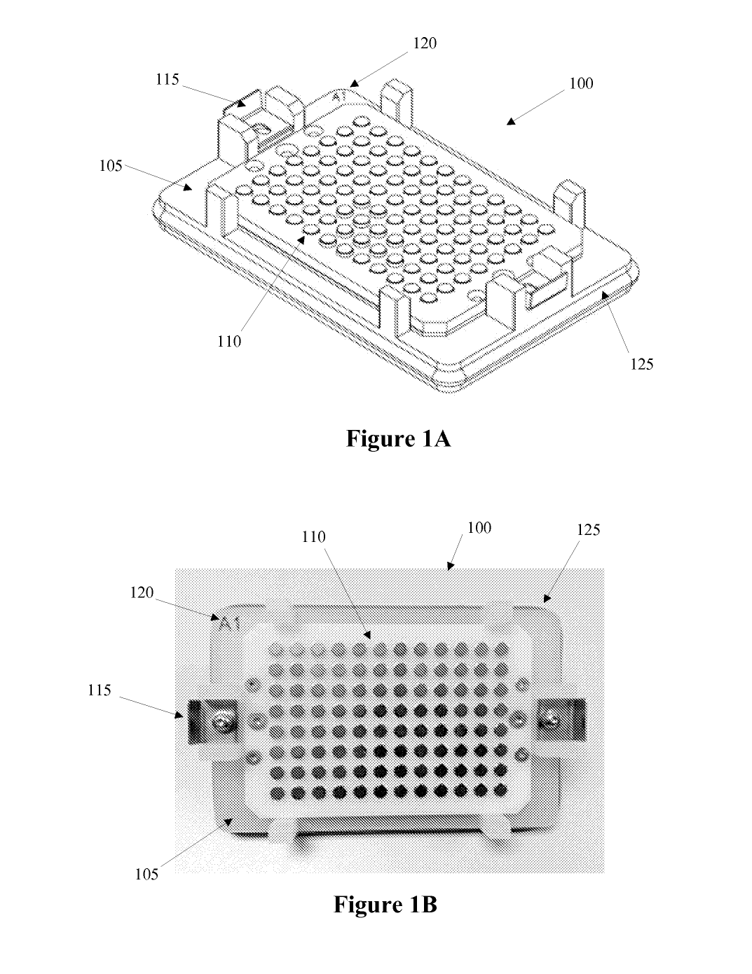

Various embodiments of the disclosed methods, devices and systems for processing magnetic particles utilize a hand held magnetic processing device, as depicted in illustrative embodiments in FIGS. 1A, 1B, 2 and 3. Such a processing device may be used for various steps of an assay, for example, washing, staining, amplification, sequencing, purification, separation or any other steps where manipulation of magnetic microparticles is required or useful.

As illustrated in FIGS. 1A, 1B, 2 and 3, some embodiments of a hand held magnetic processing device 100 include a support frame 105 upon or within which is located a plurality of magnets 110, and which includes one or more securing features 115, one or more identification features 120, and one or more gripping features 125. Support frame 105, the plurality of magnets 110, and the one or more securing features 115 are designed to enable a container to be secured to processing device 100 and in proximity to the plurality of magnets 110. For the particular embodiment illustrated in FIGS. 1A and 1B, the container may be a 96-well microtiter plate. Other embodiments may be designed to secure and process other container types, such as microtiter plates with 6, 12, 24, 48, 384 or 1536 wells, or containers of additional types with chambers, cuvettes, tubes or other structural features suitable for fluidic processing of magnetic particles.

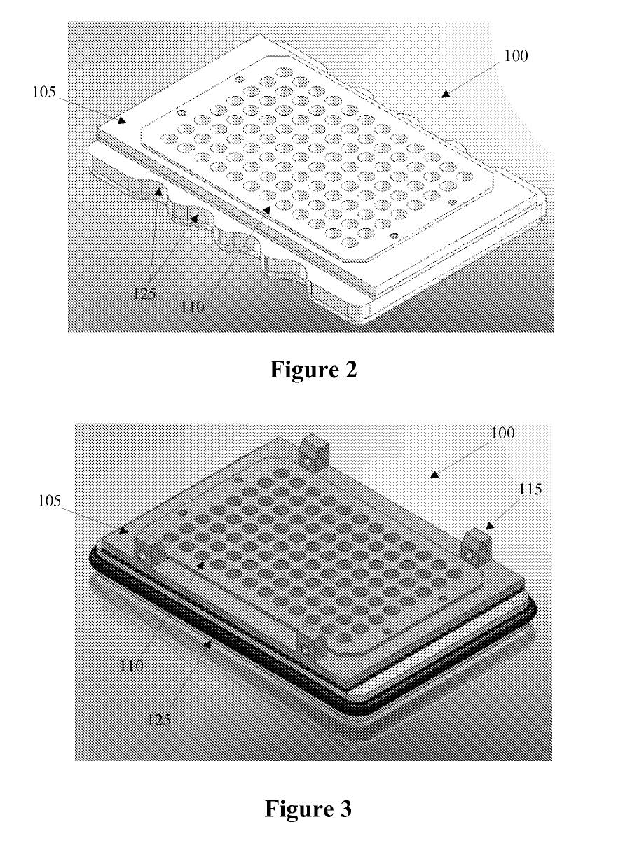

The one or more identification features 120 are features designed to guide a proper orientation of the container with processing device 100. For example, an identification feature 120 may be a character, a number, a color marking, or a physical feature, or a combination of these. In some embodiments, identification feature 120 may also prevent placement of a container in an incorrect orientation with respect to processing device 100. Not all embodiments will utilize identification features, such as the exemplary embodiments illustrated in FIGS. 2 and 3. Additionally, embodiments designed for use within automated processing instruments may also utilize identification features 120 for purposes such as proper securing and aligning of a container. Thus, identification feature 120 may be a physical feature such as a chrome marker or border, other reflective feature, or a structural feature designed to interface with the automated instrument in a limited and/or specified fashion.

The one or more gripping features 125 are designed to help users firmly grip the processing device 100 after the relevant container is secured, and subsequently remove fluid from the containers while retaining the magnetic particles within through, for example, inverting processing device 100. The gripping features 125 will vary depending on the embodiment. Examples of a gripping feature 125 include modified O-rings or a rubber gasket lining around support frame 105, as depicted in FIGS. 1A, 1B and 3. Other embodiments may utilize different aspects of the one or more gripping features 125 to aid use of the device, such as modifying the shape, material or texture of support frame 105 in certain areas. An example of these embodiments is depicted in FIG. 2, where support frame 105 has four gripping features 125 on each of the two long axes of support frame 105.

The one or more securing features 115 are designed to secure one or more containers to the support frame 105. Non-limiting examples of securing features 115 include securing tabs, as depicted in the exemplary embodiment illustrated in FIGS. 1A and 1B, latches, clips, clamps, hooks, press fit features, slides, screws and other suitable means for securely attaching one or more containers to the processing device 100, and maintaining the attachment of the one or more containers when the processing device 100 is partially or entirely inverted to remove at least a portion of any fluid in the containers while retaining the magnetic particles within.

The plurality of magnets 110 may be located on top of support frame 105, as depicted in FIGS. 1A, 1B, 2 and 3, or within support frame 105. Placing the magnets 110 on top of support 105 minimizes the distance between each individual magnet and the corresponding container, such as a well within a 96-well microtiter plate, which the magnet will influence during use of processing device 100. Minimizing the distance allows the relevant magnetic field to be stronger, and thus attract the magnetic particles within the one or more containers to the magnets 110 more quickly and more effectively. However, some embodiments may require magnets 110 to be placed within support frame 105, in which case magnets with a stronger magnetic field may be utilized, and/or assay protocols may be modified to provide additional time for magnetic particles to be drawn toward the bottom of the secured one or more containers. Magnets 110 may be any suitable magnet given the magnetic particles utilized within a particular assay. Non-limiting examples of potentially suitable magnets include permanent magnets with paramagnetic materials (e.g., neodymium, samarium) and ferromagnetic materials (e.g., iron, cobalt), ferromagnetic material magnets requiring use of an additional magnetic field to generate their own magnetic field (e.g., iron, cobalt, nickel), ferrimagnetic material magnets (e.g., magnetite, yttrium iron garnet), or hybrid magnets with both permanent magnetic materials and ferromagnetic materials. Non-limiting examples of suitable magnet types include rare earth, neodymium, neodymium iron boron, and samarium cobalt magnets.

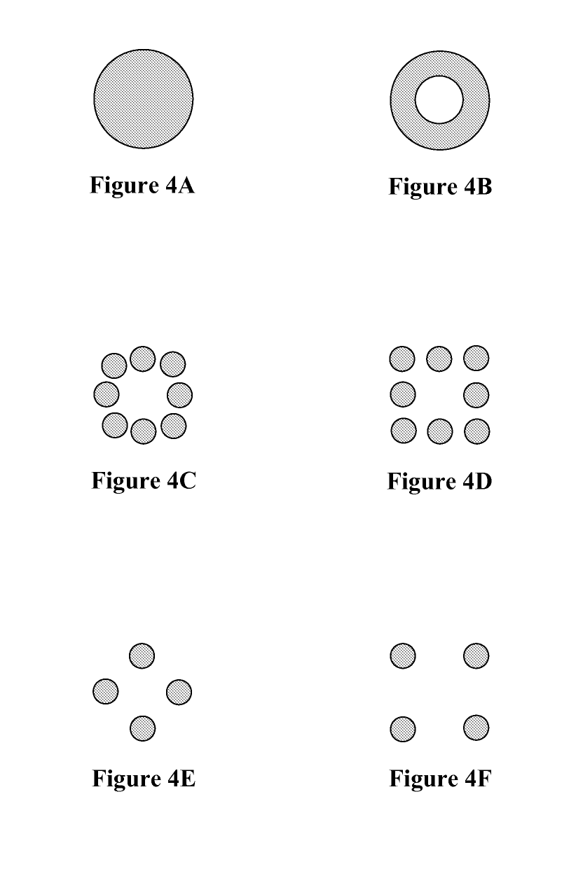

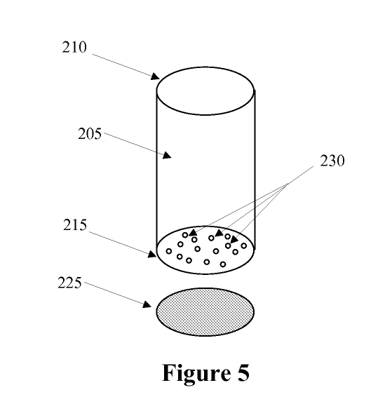

FIGS. 1A, 1B, 2 and 3 each depict embodiments with 8 rows and 12 columns of magnets 110, such that processing device 100 is optimized for use with a 96-well microtiter plate. The number and configuration of magnets 110, however, will depend on the embodiment, and the desired container. For example, other embodiments may utilize 24, 48, 384 or any other suitable number and configuration of magnets for 24, 48, 384 or other formats of microtiter plates. Additionally, other types of containers may be utilized with alternative embodiments, thus necessitating other quantities and configurations of magnets 110. The illustrative embodiments depicted in FIGS. 1A, 1B, 2 and 3 are designed such that each well of the 96-well microtiter plate is secured directly above a magnet. This aspect is depicted in FIG. 5, which shows a single well 205 of a microtiter plate and a single magnet 225. For the embodiments depicted in FIGS. 1A, 1B, 2 and 3, there would be 95 additional wells 205 and magnets 225. Thus, the magnetic field applied to each well of a particular container, such as a specific microtiter plate, will be substantially consistent from well to well, thus aiding assay consistency and predictability. Magnet 225 of FIG. 5 is a representative member of the plurality of magnets 110 in FIGS. 1A, 1B, 2 and 3. Well 205 has a top opening 210, through which magnetic particles 230 and assay fluids would enter well 205 through, for example, pipetting, and a well bottom 215. The magnet 225 draws the magnetic particles 230 toward the well bottom 215. Such an alignment of magnet 225 and well bottom 215 produces a magnetic field that is substantially uniform across well bottom 215, and will preferably result in a distribution of magnetic particles 230 that is substantially uniform on well bottom 215. While a substantially uniform distribution is still dependent on other factors, such as the manner and location of the insertion of magnetic particles 230 into well 205, this configuration of magnet 225 with respect to well 205 is advantageous in avoiding clumping of magnetic particles 230 in one specific area, such as one particular side wall of well 205, or in a concentrated area on well bottom 215. Magnets such as those depicted in FIGS. 5 and 4A, where each magnet has the same, or nearly the same, size as the well bottom 215, and is closely aligned with the well bottom 215, aid in creating a magnetic field which is substantially uniform across well bottom 215. In a preferred embodiment, magnet 225 has the same diameter as well bottom 215, and is perfectly aligned with well bottom 215 such that the center of magnet 225 is directly below the center of well bottom 215. In other embodiments, magnet 225 may possess a diameter larger or smaller than well bottom 215, but which is substantially similar such that the resulting magnetic field is still substantially uniform across well bottom 215, as this will still discourage the accumulation of magnetic particles 230 in one or more groups within well 205 at such concentrations where fluidic processing of the magnetic particles 230 and any associated probes, targets, etc. is inhibited because of the concentration. A substantially uniform distribution of magnetic particles 230 promotes faster and more through fluidic processing of magnetic particles 230 and any probes, analytes, antibodies, etc. that may be bound, attached, or otherwise associated, directly or indirectly, with the magnetic particles 230. Avoiding the clumping of magnetic particles 230 in a particular area promotes higher effectiveness of fluidic steps, such as washing. A more even and consistent distribution of magnetic particles 230 promotes a higher efficiency in the relevant fluidic steps, thus allowing each fluidic step involving processing device 100 to be performed more quickly, and thus the time required for the relevant assay to be shortened.

In alternative embodiments, magnet 225 below well 205 is replaced with one or more different magnets in various configurations. Non-limiting examples include the magnet configurations depicted in FIGS. 4B, 4C, 4D, 4E, and 4F. FIG. 4A depicts magnet 225 as illustrated within FIG. 5. The configurations of the one or more magnets within FIGS. 4B, 4C, 4D, 4E, and 4F are designed for embodiments with a different goal for the attraction of magnetic particles 230 on well bottom 215. Specifically, these embodiments wish to draw down the magnetic particles 230 substantially uniformly on well bottom 215, but without any magnetic particles 230 within the center of the well bottom 215. This allows, for example, a pipette tip to be placed at the center of well bottom 215, or slightly above well bottom 215, and aspirate any fluid without substantially disturbing any magnetic particles 230 within well 205. Thus, the desired magnetic field is still consistent from well to well of a container, but the magnetic field that is applied to each well is no longer substantially uniform. Instead, the magnetic field is stronger in the outer portions of the well, closer to the well wall, and is weaker toward the center of the well. The precise difference in the magnetic field that is applied in the outer portions compared to the more central portion of the well will depend on, for example, the size, type and configuration of the relevant magnet(s) with respect to well 205 or the container that is otherwise at issue within the assay. These magnet configuration embodiments are advantageous for use with both hand held magnetic processing device 100 and for use within instruments for automated fluidic processing such as washing and staining While use of processing device 100 may, in some embodiments, involve the inversion of processing device 100 to remove fluid from any secured containers, other embodiments may involve the removal of fluids without inversion, and/or the selective removal of fluids from only a portion of any containers secured to processing device 100. In these embodiments, it can be advantageous to have magnetic particles 230 distributed on the bottom of the well or other container at issue, but with the center of the well or container free of magnetic particles 230 so that a pipette can be inserted into the center of the bottom of the well or container to remove fluid while further minimizing the risk of aspirating magnetic particles 230. Utilizing a more central location allows for greater tolerances in the exact position to be used for fluidic transfers, as opposed to, for example, aspirating at the wall of a well, where a slight unintentional offset in positioning could result in a pipette not entering the well and instead striking the microtiter plate between wells. Other embodiments, however, utilize the insertion of a pipette tip in non-center locations, such as close to the wall of a well. Related embodiments may reduce the total number of magnets utilized within the plurality of magnets 110 by allowing at least a portion of the magnets to affect multiple wells. For example, within the magnet configuration embodiment depicted in FIG. 4D, the magnets could be placed on support frame 105 such that they are located laterally between the relevant containers, such as the wells of a microtiter plate. Such placement would still facilitate the overall goal of the embodiment of attracting magnetic particles 230 to the bottom of well 205 in a substantially uniform manner without clumping of particles, but without the attraction of particles at the center of well bottom 215, thus allowing a reduction in the number of magnets utilized within the plurality of magnets 110 for processing device 100.

Processing device 100 can be made from any suitable material or combination of materials, for example, metals such as steel or other metallic alloys, polymers such as polypropylene, polystyrene, polyvinyl chloride, polycarbonate, polysulfone, nylon and polytetrafluoroethylene, ceramics, silicon and silicon based compounds, fused)silica, quartz or glass. Some embodiments will utilize one or more components made of materials suitable for heated and/or cooled temperatures, such as when processing device 100 will be used within an assay involving, for example, nucleic acid hybridizations, or cool storage of samples and/or reagents. Non-limiting examples of such materials include CYROLITE® polymers (Evonik Cyro LLC, Parsippany, N.J.), acrylic polymers and polycarbonate.

In most embodiments, support frame105, securing features 115 and the plurality of magnets 110 do not directly interact with fluidic solutions, chemical reactants and solvents, and other substances placed in the one or more wells or other containers, and as such are not necessarily biochemically compatible with them and the overall assay at issue. It should be recognized that the exact shape of processing device 100 can differ from the illustrative embodiments depicted in FIGS. 1A, 1B, 2 and 3, and can be any suitable form, such as a rectangular, square, circular, oval, or other shape. The size of processing device 100 will also vary depending on the embodiment, and the size of the container(s) to be held. Some embodiments will utilize one or more securing features 115 that are capable of securing to support frame 105 different containers of varying sizes. For example, a single processing device 100 may be capable of securing microtiter plates of 24, 48, 96, or 384 wells, and through adjustment of one or more securing features 115, adapting to various sizes and configurations of such plates.

It is to be understood that the description in this application is not restrictive. Many variations of the invention will be apparent to those of skill in the art upon reviewing the above description. Various alternatives, modifications and equivalents are possible. The description and figures are by way of illustration and not limitation. One of skill in the art would appreciate that the invention is not limited to the specific examples provided.

### Devices, Systems and Methods for Automated Magnetic Processing Devices

Alternative embodiments are directed for use within automated instruments for higher throughput fluidic processing, such as staining or washing, of large numbers of magnetic particles 230 with a large quantity of samples. Thus, a single instrument may possess one or more sets of support frames 105 and pluralities of magnets 110 for use with multiple containers, such as multiple microtiter well plates. Alternatively, an instrument may possess a single support frame 105 with a plurality of magnets 110, and utilize this single set with multiple sets of magnetic particles 230 within a plurality of containers for processing in series. The configuration of the plurality of magnets 110 can follow any of the illustrated embodiments in FIGS. 4A-F, and any other embodiments discussed herein. While the processing of magnetic particles 230 in this manner may be automated, the overall concept of producing a magnetic field that is substantially consistent from well to well remains the same. Furthermore, some embodiments are configured to produce a magnetic field that is substantially uniform across the well bottom of each well, while other embodiments are configured to produce a magnetic field that is stronger toward the outer region of the well bottom and weaker within the center region. Thus, some embodiments will utilize the same or similar type and configuration of magnets 110 in both hand held magnetic processing devices 100 and within magnetic separation plate configurations for use within automated fluidic instruments, where the automated fluidic instruments utilize pipettes, tube manifolds or other devices to remove, and in some embodiments, add, one or more fluids to the containers with the magnetic particles 230. The advantages of faster processing through the stronger and more consistent attraction of magnetic particles 230 to the bottom of the one or more relevant containers and the gains in effectiveness of the concerned fluidic steps through the minimization of undesired clumping or concentration of magnetic particles 230 within a container such as well 205 translate to automated processing as well. In addition, the use of automated instruments with the disclosed configurations for magnets 110 can aid both effectiveness and efficiency in various fluidic steps. For instance, with magnetic configurations as depicted in FIGS. 1A, 1B, 2, 3 and 4A, magnetic particles 230 can be drawn down to well bottom 215 without a substantial amount of magnetic particles 230 above well bottom 215 in an effective and time efficient manner. Placement of one or more magnets underneath well bottom 215 such that magnetic particles 230 are attracted to well bottom 215 with a substantially uniform magnetic field minimizes the possibility of having clumps of magnetic particles 230 on a wall of well 205 and/or on well bottom 215, which may interfere with efficient fluidic processing, and in a manner that minimizes unintended removal of magnetic particles 230, and the possible loss of, for example, targets of interest from one or more samples. Subsequently, a pipette tip or manifold tube may be inserted into well 205, and any fluids which may be present can be removed while minimizing the danger of also aspirating magnetic particles 230. The pipette tip or manifold tube may be placed, for instance, near a wall of well 205, near the center of well 205, or any other suitable location near well bottom 215 for aspiration of fluids which may be present. In embodiments where fluid is removed from a more central location within well 205, magnets 110 may be configured according to the illustrated depictions in FIGS. 4B-4F. These configurations will aid in avoiding undesirable concentrations of magnetic particles 230 within well 205 while also ensuring that the center of well bottom 215 is substantially devoid of magnetic particles 230, or at least possessing a lower concentration of magnetic particles 230 in comparison to the outer regions of well bottom 215. Any suitable processing instrument capable of utilizing a configuration of magnets 110 as disclosed within the embodiments disclosed herein may be use to perform one or more fluidic processing steps of magnetic particles 230. Such steps may include the dispensing of fluid for washing purposes and the subsequent removal of the fluid. In some embodiments, instruments are configured to repeat the addition and removal of fluids to the container for multiple repetitions. Non-limiting examples of such instruments include the EL406 Combination Washer Dispenser, ELx405 Microplate Washer, and ELx50 Microplate Strip Washer (BioTek Instruments, Inc., Winooski, Vt.), BIO-PLEX PRO™ and BIO-PLEX PRO™ II Wash Stations (Bio-Rad Laboratories, Inc., Hercules, Calif.), and HYDROFLEX™ and HYDROSPEED™ Microplate Washers (Tecan Group Ltd., Switzerland).

### Assays

Fluidic processing of magnetic particles can be utilized within assays for the detection of the presence of the nucleic acids or proteins of interest in essentially any type of sample. For example, the sample can be derived from an animal, a human, a plant, a cultured cell, a virus, a bacterium, a pathogen, and/or a microorganism. The sample optionally includes a cell lysate, an intercellular fluid, a bodily fluid (including, but not limited to, blood, serum, saliva, urine, sputum, or spinal fluid), and/or a conditioned culture medium, and is optionally derived from a tissue (e.g., a tissue homogenate), a biopsy, and/or a tumor. Non-limiting examples of the sources for the nucleic acids or proteins of interest include a human, a rat, a mouse, an animal, a plant, a cultured cell, a microorganism, a virus, a bacterium, or a pathogen.

As noted, the methods can be used for gene expression analysis. Accordingly, in one class of embodiments, the two or more nucleic acids of interest comprise two or more mRNAs. The methods can also be used for clinical diagnosis and/or detection of microorganisms, e.g., pathogens. Thus, in certain embodiments, the nucleic acids include bacterial and/or viral genomic RNA and/or DNA (double-stranded or single-stranded), plasmid or other extra-genomic DNA, or other nucleic acids derived from microorganisms (pathogenic or otherwise). It will be evident that double-stranded nucleic acids of interest will typically be denatured before hybridization with capture extenders, label extenders, and the like.

Basic bDNA assays have been well described. For example, U.S. Pat. No. 4,868,105 to Urdea et al. entitled “Solution phase nucleic acid sandwich assay”; U.S. Pat. No. 5,635,352 to Urdea et al. entitled “Solution phase nucleic acid sandwich assays having reduced background noise”; U.S. Pat. No. 5,681,697 to Urdea et al. entitled “Solution phase nucleic acid sandwich assays having reduced background noise and kits therefor”; U.S. Pat. No. 5,124,246 to Urdea et al. entitled “Nucleic acid multimers and amplified nucleic acid hybridization assays using same”; U.S. Pat. No. 5,624,802 to Urdea et al. entitled “Nucleic acid multimers and amplified nucleic acid hybridization assays using same”; U.S. Pat. No. 5,849,481 to Urdea et al. entitled “Nucleic acid hybridization assays employing large comb-type branched polynucleotides”; U.S. Pat. No. 5,710,264 to Urdea et al. entitled “Large comb type branched polynucleotides”; U.S. Pat. No. 5,594,118 to Urdea and Horn entitled “Modified N-4 nucleotides for use in amplified nucleic acid hybridization assays”; U.S. Pat. No. 5,093,232 to Urdea and Horn entitled “Nucleic acid probes”; U.S. Pat. No. 4,910,300 to Urdea and Horn entitled “Method for making nucleic acid probes”; U.S. Pat. No. 5,359,100; U.S. Pat. No. 5,571,670; U.S. Pat. No. 5,614,362; U.S. Pat. No. 6,235,465; U.S. Pat. No. 5,712,383; U.S. Pat. No. 5,747,244; U.S. Pat. No. 6,232,462; U.S. Pat. No. 5,681,702; U.S. Pat. No. 5,780,610; U.S. Pat. No. 5,780,227 to Sheridan et al. entitled “Oligonucleotide probe conjugated to a purified hydrophilic alkaline phosphatase and uses thereof”; U.S. patent application Publication No. US2002172950 by Kenny et al. entitled “Highly sensitive gene detection and localization using in situ branched-DNA hybridization”; Wang et al. (1997) “Regulation of insulin preRNA splicing by glucose” Proc Nat Acad Sci USA 94:4360-4365; Collins et al. (1998) “Branched DNA (bDNA) technology for direct quantification of nucleic acids: Design and performance” in Gene Quantification, F Ferre, ed.; and Wilber and Urdea (1998) “Quantification of HCV RNA in clinical specimens by branched DNA (bDNA) technology” Methods in Molecular Medicine: Hepatitis C 19:71-78. In addition, kits for performing bDNA assays, such as QUANTIGENE® Assay Kits, comprising instructions and reagents such as amplification multimers, alkaline phosphatase labeled label probes, chemilumigenic substrate, capture probes immobilized on a solid support, and the like) are commercially available from, for example, Affymetrix, Inc. (Santa Clara, Calif.).

Among other aspects, methods are provided to be used in a multiplex DNA or RNA assay that can be used for simultaneous detection of two or more target nucleic acids. Examples of multiplex bDNA assay can be found, for example, in U.S. Pat. No. 7,803,541 to Luo et al. and U.S. Patent Application Publication No. 2006/0263769 by Luo et al. The entire disclosure of these applications cited is incorporated by reference in its entirety for all purposes as well as for the proposition that is recited.

The assay temperature and the stability of the complex between a single capture extender and its corresponding capture probe can be controlled such that binding of a single capture extender to a nucleic acid and to the capture probe is not sufficient to stably capture the nucleic acid on the surface to which the capture probe is bound, whereas simultaneous binding of two or more capture extenders to a nucleic acid can capture it on the surface. Assays with requirements of such cooperative hybridization involving multiple capture extenders for each nucleic acid of interest produce results that are high in specificity and with low background from cross-hybridization of the capture extenders with other, non-targeted nucleic acids. For an assay to achieve high specificity and sensitivity, it preferably has a low background, resulting, for example, from minimal cross-hybridization. Such low background and minimal cross-hybridization are typically substantially more difficult to achieve in a multiplex assay than a single-plex assay, because the number of potential nonspecific interactions are greatly increased in a multiplex assay due to the increased number of probes used in the assay (e.g., the greater number of capture extenders and label extenders). Requiring multiple simultaneous capture extender-capture probe interactions for the capture of a target nucleic acid minimizes the chance that nonspecific capture will occur, even when some nonspecific capture extender-capture probe interactions do occur.

Furthermore, assays utilizing fluidic processing with magnetic separation according to the disclosed embodiments can be used for multiplex detection of two or more nucleic acids simultaneously, for example, from even complex samples, without requiring prior purification of the nucleic acids, when the nucleic acids are present at low concentration, and/or in the presence of other, highly similar nucleic acids. In one aspect, the methods involve capture of the nucleic acids to particles (e.g., distinguishable subsets of particles), while in another aspect, the nucleic acids are captured to a spatially addressable solid support. Particles can also be used simply to purify sample of genetic material or to enrich sample for specific populations of genetic material.

### Systems

In some aspects, systems are used to practice the methods herein of separating magnetic particles and/or include the devices as disclosed herein. The system can include, for example, a hand held magnetic processing device, a fluid and/or microsphere handling element, a fluid and/or microsphere containing element, a laser for exciting a fluorescent label and/or fluorescent microspheres, a detector for detecting light emissions from a chemiluminescent reaction or fluorescent emissions from a fluorescent label and/or fluorescent microspheres, and/or a robotic element that moves other components of the system from place to place as needed (e.g., a multiwell plate handling element). For example, in some embodiments, a system such as the LUMINEX® 100/200™ System (Austin, Tex.), including an analyzer, plate handling platform, fluid delivery system, software and a computer, are utilized.

The system can optionally include a computer. The computer can include appropriate software for receiving user instructions, either in the form of user input into a set of parameter fields, for example, in a graphical user interface (GUI), or in the form of preprogrammed instructions, such as preprogrammed instructions for a variety of specific operations. The software optionally converts these instructions to appropriate language for controlling the operation of components of the system (e.g., for controlling a fluid handling element, robotic element and/or laser). The computer can also receive data from other components of the system, e.g., from a detector, and can interpret the data, provide it to a user in a human readable format, or use that data to initiate further operations, in accordance with any programming by the user.

### Labels

A wide variety of labels is well known in the art and can be adapted for use depending on the particular requirements and desired characteristics of an assay. The particular label used with magnetic particles 230 may be any suitable label known in the art. The label may be, for example, a fluorescent label, such as an organic dye (e.g., fluorescein, Cy3, Cy5, rhoadamine), a biological fluorophore (e.g., phycoerythrocyanin), or a quantum dot (e.g., a carboxyl quantum dot). Fluorescent labels may include, for example, N-hydroxysuccinimide ester activated dyes that react with exposed amino groups, malemide activated dyes that react with sulfhydryl groups, phosphine activated dyes that react with azide groups, or other suitable labels known in the art. Depending on the embodiment, suitable labels may be available commercially from, for example, Invitrogen (Carlsbad, Calif.), Thermo Fisher Scientific (Waltham, Mass.), and ATTO-TEC GmbH (Siegen, Germany). See also, Haughland, Handbook of Fluorescent Probes and Research Products, Ninth Edition (2003); and The Handbook: A Guide to Fluorescent Probes and Labeling Technologies, Tenth Edition (2006) from Invitrogen for descriptions of fluorophores emitting at various different wavelengths (including tandem conjugates of fluorophores that can facilitate simultaneous excitation and detection of multiple labeled species). For use of quantum dots as labels for biomolecules, see e.g., Dubertret et al., Science, 298: 1759-1762 (2002); Wu et al., Nature Biotechnology, 21: 41-46 (2002); and Jaiswal et al., Nature Biotechnology, 21: 47-51 (2002). Other non-limiting examples of labels include luminescent labels and light-scattering labels (e.g., colloidal gold particles), such as those described within Csaki et al., “Gold nanoparticles as novel label for DNA diagnostics,” Expert Rev. Mol. Diagn., 2(2): 187-193 (2002).

Labels can be introduced to molecules, e.g. polynucleotides or polypeptides, during synthesis or by post synthetic reactions by techniques established in the art or to samples of such molecules through for example, kits for fluorescent labeling with various fluorophores available from, for example, Life Technologies Corporation (Carlsbad, Calif. Similarly, signals from the labels (e.g., absorption by and/or fluorescent emission from a fluorescent label) can be detected by any suitable method known in the art for the particular assay in question, such as through multicolor detection, detection of FRET, or fluorescence polarization.

### Molecular Biological Techniques

In practicing the methods, many conventional techniques in molecular biology, microbiology, and recombinant DNA technology are optionally used. These techniques are well known and are explained in, for example, Berger and Kimmel, Guide to Molecular Cloning Techniques, Methods in Enzymology volume 152 Academic Press, Inc., San Diego, Calif.; Sambrook et al., Molecular Cloning—A Laboratory Manual (3rd Ed.), Vol. 1-3, Cold Spring Harbor Laboratory, Cold Spring Harbor, N.Y., 2000 and Current Protocols in Molecular Biology, F. M. Ausubel et al., eds., Current Protocols, a joint venture between Greene Publishing Associates, Inc. and John Wiley & Sons, Inc., (supplemented through 2005). Other useful references, e.g. for cell isolation and culture (e.g., for subsequent nucleic acid or protein isolation) include Freshney (1994) Culture of Animal Cells, a Manual of Basic Technique, third edition, Wiley-Liss, New York and the references cited therein; Payne et al. (1992) Plant Cell and Tissue Culture in Liquid Systems John Wiley & Sons, Inc. New York, N.Y.; Gamborg and Phillips (Eds.) (1995) Plant Cell, Tissue and Organ Culture; Fundamental Methods Springer Lab Manual, Springer-Verlag (Berlin Heidelberg N.Y.) and Atlas and Parks (Eds.) The Handbook of Microbiological Media (1993) CRC Press, Boca Raton, Fla.

### Making Polynucleotides

Methods of making nucleic acids (e.g., by in vitro amplification, purification from cells, or chemical synthesis), methods for manipulating nucleic acids (e.g., by restriction enzyme digestion, ligation, etc.) and various vectors, cell lines and the like useful in manipulating and making nucleic acids are described in the above references. In addition, methods of making branched polynucleotides (e.g., amplification multimers) are described in U.S. Pat. No. 5,635,352, U.S. Pat. No. 5,124,246, U.S. Pat. No. 5,710,264, and U.S. Pat. No. 5,849,481, as well as in other references mentioned above. In addition, essentially any polynucleotide (including, e.g., labeled or biotinylated polynucleotides) can be custom or standard ordered from any of a variety of commercial sources, such as The Midland Certified Reagent Company (Midland, Tex.), Sigma-Aldrich (St. Louis, Mo.), or Life Technologies Corporation (Carlsbad, Calif.).

A label, biotin, or other moiety can optionally be introduced to a polynucleotide, either during or after synthesis. For example, a biotin phosphoramidite can be incorporated during chemical synthesis of a polynucleotide. Alternatively, any nucleic acid can be biotinylated using techniques known in the art; suitable reagents are commercially available, e.g., from Pierce Biotechnology, Inc. (Rockford, Ill.). Similarly, any nucleic acid can be fluorescently labeled, for example, by using commercially available kits such as those from Life Technologies Corporation or by incorporating a fluorescently labeled phosphoramidite during chemical synthesis of a polynucleotide.

### EXAMPLES

### Example 1

A hand held magnetic processing device is used within the QUANTIGENE® Plex (Affymetrix, Inc., Santa Clara, Calif.) assay configured for magnetic separation as per the instructions listed below. In this example, the processing device is a magnetic plate washer, the container is a 96 flat bottom well microtiter plate, and the magnetic particles are magnetic capture microspheres. The magnetic plate washer is used with the 96 flat bottom well microtiter plate to enable quick and easy processing of the washing steps after each incubation within the assay. The operating instructions below apply to each wash step that was required in the QUANTIGENE® Plex assay, starting with the wash step after the overnight hybridization step captures the RNA.

### Before Using the Hand Held Magnetic Plate Washer

Step 1. Set up the LUMINEX® (Austin, Tex.) instrument according to manufacturer's published protocols.

Step 2. Define a protocol with the appropriate microsphere regions and set to read 2 wells.

Step 3. Vortex capture microspheres, for example at a speed of 3000 rpm for 30 seconds.

Step 4. Add 2.5 microliters of capture microspheres (magnetic particles conjugated with oligonucleotides) to 250 microliter of Streptavidin-Phycoerythrin (SAPE) wash buffer. Vortex to mix.

Step 5. Add 100 microliters of the capture microsphere mixture into each of 2 wells on the microtiter plate.

Step 6. Perform a series of wash steps using the SAPE wash buffer to simulate the multiple wash steps in the assay.

Step 7. After the final wash step, add 130 microliters of SAPE wash buffer to each well. Cover the plate with aluminum foil seal, place on a shaking platform at room temperature and shake for 2-5 minutes to completely re-suspend the capture microspheres.

Step 8. Insert the microtiter plate into the flow cytometer instrument, for example, a LUMINEX® 100/200 analyzer reader, and read the 2 wells to collect particles count data.

Step 9. View the window with the microsphere regions and DD gate.

Loading the Microtiter Plate with Sample.

After the LUMINEX® instrument is set up, the user loads the sample, including the magnetic capture microspheres onto a 96 flat bottom well microtiter plate. Complete the transfer of sample to the 96 flat bottom well microtiter plate within 10 minutes.

Step 1. Remove the hybridization plate from the shaking incubator, and centrifuge at 240×g for 1 minute.

Step 2. Adjust the temperature of the shaking incubator to 50 +/−1 degrees Celsius. Verify the temperature using a QUANTIGENE® Incubator Temperature Validation Kit.

Step 3. Mix the contents in the hybridization plate by pipetting up and down 5 times and then transfer the entire content to the 96 flat bottom well microtiter plate.

Washing QUANTIGENE® Plex Assa Plates with the Hand Held Magnetic Plate Washer

After the user loads the sample, including the magnetic captures microspheres onto a microtiter plate, the user uses the hand held magnetic plate washer to wash the magnetic capture microspheres. These instructions apply to each step of the QUANTIGENE® Plex assay that requires washing of the capture microspheres in the microtiter plate. These wash steps are included in:
Capturing target RNA or DNA
Signal amplification and detection

To wash the capture microspheres in the microtiter plate:

Step 1. Insert the microtiter plate into the hand held magnetic plate washer so that the A1 location (identifier feature 120) is in the correct position and orientation.

Step 2. Lock the plate in place by pushing the two tabs (securing features 115), located on each end of the washer, towards the plate until they overlap the skirt of the plate. Verify the plate is securely locked by holding the assembly in the palm of your hand and gently pulling up on the microtiter plate.

Step 3. Wait 60 seconds to allow the capture microspheres to accumulate at the bottom of each well.

Step 4. Place the securely locked assembly in the palm of your hand. Grip the unit firmly by wrapping your fingers around the rubber gasket. Invert the assembly over an appropriate receptacle and expel the contents forcibly. Firmly tap the inverted assembly on a clean paper towel to dry.

Step 5. To wash the capture microspheres in the microtiter plate:
a. Add 100 micro liters of wash buffer to each well.
b. Wait 15 seconds to allow the capture microspheres to accumulate at the bottom of each well.
c. Invert the assembly over an appropriate receptacle and expel the contents forcibly. Firmly tap the inverted plate on a clean paper two to dry.
d. Repeat steps 5a-5c two more times for a total of 3 washes. Note: Ensure the microtiter plate remains securely locked in place throughout each series of wash steps.

Step 6. Remove the microtiter plate from the device by releasing the securing tabs, then proceed to the next assay step.

Step 7. Mix the contents in the hybridization plate by pipetting up and down 5 times and then transfer the entire content to the microtiter plate.

### Example 2

A hand held magnetic processing device is also used with the PROCARTA® Cytokine assay (Affymetrix, Inc., Santa Clara, Calif.) as per the instructions listed below. In this example, the hand held magnetic device is a hand held magnetic plate washer, the container is a 96 flat bottom well microtiter plate, and the magnetic particles are magnetic microspheres conjugated with antibodies.

Step 1. Collect and prepare samples, antigen standards, and 1× wash buffer.

Step 2. Add magnetic microspheres conjugated with antibodies in buffer. Place the microtiter plate on the hand held magnetic plate washer. Add the wash buffer to the wells of the microtiter plate. Invert the assembly over an appropriate receptacle and expel the buffer. Firmly tap the inverted plate on a clean paper two to dry. Remove the microtiter plate from the hand held magnetic plate washer such that the magnetic microspheres are free to move around in the wells.

Step 3. Add samples/standards. Incubate 60 minutes shaking at 700 rpm at room temperature. Place the microtiter plate on the hand held magnetic plate washer. Add the wash buffer to the wells of the microtiter plate. Invert the assembly over an appropriate receptacle and expel the contents forcibly. Firmly tap the inverted plate on a clean paper two to dry. Repeat washing step three times. Remove the microtiter plate from the hand held magnetic plate washer.

Step 4. Add detection antibody. Incubate plate for 30 minutes shaking at 700 rpm at room temperature. Place the microtiter plate on the hand held magnetic plate washer. Add the wash buffer to the wells of the microtiter plate. Invert the assembly over an appropriate receptacle and expel the contents forcibly. Firmly tap the inverted plate on a clean paper two to dry. Repeat washing step three times. Remove the microtiter plate from the hand held magnetic plate washer.

Step 5. Add Streptavidin Phycoerythrin. Incubate plate for 30 minutes, shaking at 700 rpm at room temperature. Place the microtiter plate on the hand held magnetic plate washer. Add the wash buffer to the wells of the microtiter plate. Invert the assembly over an appropriate receptacle and expel the contents forcibly. Firmly tap the inverted plate on a clean paper two to dry. Repeat adding and removing wash buffer step three times.

Step 6. Insert the microtiter plate into the flow cytometer instrument and read the wells to collect particle count data.

What is claimed is:

1. A magnetic particle processing device, the device comprising:
a support frame, wherein the support frame comprises a top surface;
one or more securing features, wherein the one or more securing features are designed to secure a container to the top surface, and wherein the container comprises a plurality of wells; and
a plurality of magnets, wherein the plurality of magnets is located on the top surface, and wherein the plurality of magnets is configured such that a magnetic field is produced that is substantially consistent for each well of the container.

2. The device of claim 1, wherein the device additionally comprises one or more identification features.

3. The device of claim 1, wherein the device additionally comprises one or more gripping features.

4. The device of claim 1, wherein the container is a microtiter well plate.

5. The device of claim 4, wherein the microtiter well plate comprises 96 wells.

6. The device of claim 1, wherein the one or more securing features are designed such that different containers can be secured to the top surface.

7. The device of claim 6, wherein the different containers comprise different quantities of wells.

8. The device of claim 1, wherein each well comprises a well bottom, and wherein the plurality of magnets is configured such that the magnetic field is substantially uniform across the well bottom of each well.

9. The device of claim 8, wherein the plurality of magnets is configured such that each well is directly above one magnet, wherein each magnet possesses a magnet diameter, wherein each well bottom possesses a well bottom diameter, and wherein the magnet diameter is approximately equal to the well bottom diameter.

10. The device of claim 1, wherein each well comprises a well bottom, and wherein the plurality of magnets is configured such that the magnetic field is weaker within a center region of the well bottom of each well and is stronger within an outer region of the well bottom of each well.

11. A system for processing magnetic particles, the system comprising:
a container, wherein the container comprises a plurality of wells configured to hold a fluid and a plurality of magnetic particles; and
a fluidic processing instrument, wherein the fluidic processing instrument comprises one or more sets of magnets, wherein the fluidic processing instrument is configured to align a set of magnets with the container such that a magnetic field is produced that is substantially consistent for each well of the container, and wherein the fluidic processing instrument is configured to remove the fluid from the wells of the container.

12. The system of claim 11, wherein the fluidic processing instrument is configured to dispense fluid into the wells of the container.

13. The system of claim 12, wherein the fluidic processing instrument is configured to perform repetitions of dispensing fluid into the wells of the container and removing fluid from the wells of the container.

14. The system of claim 11, wherein each well comprises a well bottom, and wherein the one or more sets of magnets are configured such that the magnetic field is substantially uniform across the well bottom of each well.

15. The system of claim 14, wherein fluidic processing instrument is configured to align the container with the set of magnets such that each well is directly above one magnet, wherein each magnet possesses a magnet diameter, wherein each well bottom possesses a well bottom diameter, and wherein the magnet diameter is approximately equal to the well bottom diameter.

16. The system of claim 11, wherein each well comprises a well bottom, and wherein the one or more sets of magnets are configured such that the magnetic field is weaker within a center region of the well bottom of each well and is stronger within an outer region of the well bottom of each well.

17. A method for processing a plurality of magnetic particles, the method comprising:
aligning a plurality of magnets with a container, wherein the container comprises a plurality of wells, wherein each well comprises a well bottom, wherein at least one well contains a fluid and a plurality of magnetic particles, and wherein the plurality of magnets is aligned with the container such that a magnetic field is produced that is substantially consistent for each well of the container;
allowing the plurality of magnets to attract the plurality of magnetic particles to the well bottom of the at least one well; and
removing the fluid from the at least one well.

18. The method of claim 17, additionally comprising dispensing one or more fluids into the at least one well.

19. The method of claim 18, wherein the steps of removing and dispensing are repeated one or more times.

20. The method of claim 17, wherein the magnetic field is substantially uniform across the well bottom of each well.

21. The method of claim 17, wherein the magnetic field is weaker within a center region of the well bottom of each well and is stronger within an outer region of the well bottom of each well.

22. The method of claim 17, wherein the fluid is removed from the at least one well from the center region.
